(19) United States
(12) Patent Application Publication
(10) Pub. No.: US 2018/0327601 A1
(43) Pub. Date: Nov. 15, 2018

(54) POLYMER COMPOSITION COMPRISING A DISPERSED PLANT MATERIAL

(71) Applicant: ARKEMA FRANCE, Colombes (FR)

(72) Inventors: Jean-Marc BOUTILLIER, Sauvagnon (FR); Axel SALINIER, Pau (FR)

(73) Assignee: ARKEMA FRANCE, Colombes (FR)

(21) Appl. No.: 15/774,136

(22) PCT Filed: Nov. 15, 2016
(86) PCT No.: PCT/FR2016/052959

§ 371 Date: May 7, 2018

(30) Foreign Application Priority Data
Nov. 16, 2015 (FR) 1560946

(51) Int. Cl. C08L 97/00; C08L 53/00; C08J 5/04; C08F 220/18; C08F 214/22; C08F 212/08

(52) U.S. Cl. CPC C08L 97/007; C08L 53/00; C08F 212/08; C08F 220/18; C08F 214/22; C08J 5/045

(57) ABSTRACT

Provided is a composition including a polymer matrix having an elastomer phase with a glass transition temperature of less than or equal to 20° C. and particles of cork which are dispersed in the polymer matrix. Also provided is a process for preparing the composition by hot-mixing the polymer matrix in a softened state with the particles of cork and optionally with one or more additives, in an extruder, the particles of cork being introduced laterally after the introduction of the polymer matrix which is introduced into the feeder at the beginning of extrusion.

### FIELD OF THE INVENTION

The present invention relates to a composite material comprising a polymer matrix and also dispersed plant material particles, and also articles which can be manufactured from this composite material.

### TECHNICAL BACKGROUND

Plant materials such as cork have many advantageous properties, in terms for example of thermal insulation, of sound insulation, of natural appearance, of lightness and of pleasant odor.

However, these materials, and in particular cork, often have the drawback of being readily friable and brittle. They cannot therefore be employed according to the techniques commonly used for thermoplastics, such as injection molding, extrusion, extrusion-blow molding, thermoforming, etc.

In order to overcome the drawbacks associated with the use of pure plant materials (such as cork), said materials can be mixed with a polymer.

Thus, document CN 104608270, according to its abstract, describes a mixture of cork and of ethylene-vinyl acetate. The cork is combined beforehand with natural rubber. However, natural rubber is known to have a very poor resistance to UV-radiation, and furthermore it must be crosslinked in order to prevent it from creeping, in particular at high temperature.

Document FR 2451350 describes a layer based on a mixture of particles of cork and ethylene-vinyl acetate which is bonded, via an adhesive, to a floor.

Document US 2010/0319282 describes a floor coating which comprises several layers, one of which consists of a mixture of cork and polyvinyl chloride.

There is a need to produce various articles based on plant materials such as cork, using the conventional techniques for processing thermoplastics, and without impairing the properties of the plant material, for example with processing at a temperature of less than 200° C. There is also a need for these articles, based on plant materials such as cork and processed using the techniques used for thermoplastics, to have good impact strength and to have excellent resistance to UV-rays.

### SUMMARY OF THE INVENTION

The invention relates first to a composition comprising:
a polymer matrix comprising an elastomer phase having a glass transition temperature of less than or equal to 20° C.;
particles of plant material which are dispersed in said polymer matrix.

According to one embodiment, the particles of plant material have a density of less than or equal to 500 kg/m³, preferably less than or equal to 200 kg/m³, more particularly preferably less than or equal to 150 kg/m³, or even less than or equal to 100 kg/m³.

According to one embodiment, the particles of plant material are wood particles, and preferably cork particles.

The particles may be in the form of granules or powder.

According to a first embodiment, the elastomer phase represents at least 1% by weight, preferably at least 5% by weight, more particularly preferably at least 10% by weight and even more preferentially at least 15% by weight, relative to the total weight of the composition.

According to this first embodiment, the ratio of the weight content of particles of plant material to the weight content of elastomer phase is less than or equal to 1, preferably less than or equal to 0.9 and more preferentially less than or equal to 0.8.

According to a second embodiment, the polymer matrix comprises at least one block copolymer, the elastomer phase being at least partially made up of at least one block of the block copolymer, and preferably the block copolymer is an acrylic block copolymer.

According to this second embodiment, the ratio of the weight content of particles of plant material to the weight content of elastomer phase of the block copolymer is greater than or equal to 1, but less than or equal to 3 and preferably less than or equal to 1.5.

According to this second embodiment, the composition comprises:
from 30% to 99% by weight of block copolymer, preferably from 40% to 95% by weight, and more particularly preferably from 50% to 90% by weight;
from 1% to 70% by weight of particles of plant material, preferably from 5% to 60% by weight, and more particularly preferably from 10% to 50% by weight.

According to one embodiment, the block copolymer comprises at least one block A having a glass transition temperature of greater than or equal to 50° C., preferably greater than or equal to 80° C., and at least one block B having a glass transition temperature of less than or equal to 20° C., which at least partially constitutes the elastomer phase.

According to one embodiment, the block B represents from 10% to 90% of the total weight of the block copolymer, preferably from 20% to 80% and more preferably from 30% to 70%.

According to one embodiment, the block B has a weight-average molar mass of between 10 000 g/mol and 300 000 g/mol, preferentially between 20 000 and 150 000 g/mol.

According to one embodiment, the block A is an acrylic or methacrylic homopolymer or copolymer block, or a polystyrene block, or an acrylic-styrene copolymer block or a methacrylic-styrene block, preferably a poly(methyl methacrylate), poly(phenyl methacrylate), poly(benzyl methacrylate) or poly(isobornyl methacrylate) block, and more preferably a poly(methyl methacrylate) block, optionally modified with acrylic or methacrylic comonomers.

According to one embodiment, the block B is an acrylic or methacrylic homopolymer or copolymer block which can contain styrene, preferably a poly(methyl acrylate), poly(ethyl acrylate), poly(butyl acrylate), poly(ethylhexyl acrylate) or poly(butyl methacrylate) block, and more preferably a poly(butyl acrylate) block.

According to one embodiment, the block copolymer is chosen from the following triblock copolymers:
poly(methyl methacrylate)/poly(butyl acrylate)/poly(methyl methacrylate),
copolymer of methyl methacrylate and of methacrylic acid/poly(butyl acrylate)/copolymer of methyl methacrylate and of methacrylic acid,
poly(methyl methacrylate)/copolymer of butyl acrylate and of styrene/poly(methyl methacrylate), and
copolymer of methyl methacrylate and of methacrylic acid/copolymer of butyl acrylate and of styrene/copolymer of methyl methacrylate and of methacrylic acid,
polystyrene/poly(butyl acrylate)/polystyrene,
poly(styrene-co-methacrylic acid)/poly(butyl acrylate)/poly(styrene-co-methacrylic acid).

According to one embodiment, the block copolymer is chosen from the following diblock copolymers:
poly(methyl methacrylate)/poly(butyl acrylate),
copolymer of methyl methacrylate and of methacrylic acid/poly(butyl acrylate),
polymer of methyl methacrylate/copolymer of butyl acrylate and of styrene, and
copolymer of methyl methacrylate and of methacrylic acid/copolymer of butyl acrylate and of styrene.

According to one embodiment, the composition is blown by means of a chemical blowing agent and/or a blowing gas.

According to one embodiment, the composition of the invention also comprises a thermoplastic polymer, preferably a fluoropolymer and more particularly preferably polyvinylidene fluoride.

The invention also relates to a process for preparing a composition as described above, comprising:
providing the polymer matrix and also the particles of plant material;
hot-mixing the polymer matrix in the softened state and comprising the elastomer phase with the particles of plant material, preferably in an extruder, the plant particles being introduced laterally after the introduction of the polymer matrix which is introduced into the feeder at the beginning of extrusion.

The invention also relates to an article comprising the composition described above, preferably chosen from sheets and in particular insulation sheets, films, profiled parts, outer casings, domestic electrical appliances, spectacles and soles.

The present invention makes it possible to overcome the drawbacks of the prior art. It more particularly provides a composition containing plant materials such as cork, which can be formed by the conventional techniques of thermoplastics in order to produce various articles.

This forming can be carried out rapidly and at relatively low temperature, which makes it possible to avoid impairing the properties of the plant material.

The invention also makes it possible to manufacture objects of complex shape and/or of small thickness, for example spools of films, slabs or sheets of great length, by extrusion.

The invention also makes it possible to manufacture objects which have excellent resistance to UV-radiation and which can therefore be used for outside applications.

The material of the invention is flexible and impact resistant. It advantageously has a natural appearance and also a pleasant odor, owing to the presence of the plant material.

These various advantages are obtained in particular by virtue of a composition comprising particles of plant material (in particular of cork or the like) in a polymer matrix comprising an elastomer phase with a low glass transition temperature, which is preferentially provided by an acrylic block copolymer.

Compared with the same material comprising an elastomer phase devoid of plant material (for example compared with the acrylic block copolymer as such), the composite material of the invention advantageously has improved antistatic, thermal and sound properties, and also an appearance very close to that of the plant material.

### DESCRIPTION OF EMBODIMENTS OF THE INVENTION

The invention is now described in greater detail and in a nonlimiting manner in the description which follows.

The composition of the invention is a composite material which comprises at least one polymer matrix and particles dispersed in the polymer matrix.

The term “polymer matrix” is intended to mean the non-plant phase, regardless of the proportion of polymer in the polymer-plant material mixture.

The polymer matrix comprises an elastomer phase having a glass transition temperature of less than 20° C.

This elastomer phase is formed by a macromolecular sequence, which may be a polymer, or by a part of a polymer (such as one or more blocks of block copolymers), or a blend of polymers and/or of parts of polymers.

Preferably, the polymer matrix comprises at least one block copolymer, and the elastomer phase is at least partially formed, preferably is totally formed, by at least one block of the block copolymer.

The block copolymer can be a diblock or triblock copolymer, or it can comprise four, five or more than five blocks.

Diblock and triblock copolymers are preferred.

Preferably, the block copolymer is an acrylic block copolymer; it is a block copolymer, at least one block of which is at least partially formed from acrylic monomers.

According to one preferred embodiment, all the blocks are at least partially formed from acrylic monomers.

According to one preferred embodiment, at least one block is totally formed from acrylic monomers.

According to one preferred embodiment, all the blocks are totally formed from acrylic monomers.

The term “acrylic monomers” is intended to mean monomers comprising a substituted or unsubstituted vinyl group, and a carboxylic acid group, optionally in salt or ester form.

They include in particular the following monomers: acrylate, methacrylate, acrylic acid, methacrylic acid, methyl methacrylate, phenyl methacrylate, benzyl methacrylate, isobornyl methacrylate, methyl acrylate, ethyl acrylate, butyl acrylate, ethylhexyl acrylate, butyl methacrylate.

Particularly preferably, the block copolymer is an amorphous copolymer.

Particularly preferably, the block copolymer is a thermoplastic copolymer.

The term “thermoplastic” is intended to mean herein a polymer which softens when it is heated to a sufficiently high temperature, and which can therefore be reshaped by application of heat and pressure.

According to one particularly preferred embodiment, the block (preferably acrylic block) copolymer comprises at least one block A and at least one block B, in which the block A has a glass transition temperature of greater than or equal to 50° C. and the block B constitutes the elastomer phase mentioned above, and therefore has a glass transition temperature of less than or equal to 20° C.

In particular embodiments, the block A has a glass transition temperature of greater than or equal to 60° C.; or greater than or equal to 70° C.; or greater than or equal to 80° C.; or greater than or equal to 90° C.; and the block B has a glass transition temperature of less than or equal to 15° C.; or less than or equal to 10° C.; or less than or equal to 5° C.; or less than or equal to 0° C.

The glass transition temperature can be determined by differential scanning calorimetry (DSC), according to the standard ASTM E1356.

The function of the block A is in particular to confer rigidity and hardness on the copolymer and therefore on the composite material. The function of the block B is in particular to confer flexibility and impact strength on the copolymer and therefore on the composite material. The block B also makes it possible to ensure mixing and optimal contact between the copolymer and the plant material.

The block copolymer (in particular acrylic block copolymer) can in particular be a copolymer of structure AB, or ABA, or A₃B, or A₄B, or more generally AₙB with n an integer greater than or equal to 1. The AB and ABA structures are particularly preferred.

When several blocks A are present, they are preferably identical. According to one alternative embodiment, they may be different.

The block B preferably represents from 10% to 90%, preferentially from 20% to 80% and more preferably from 30% to 70% of the total weight of the block copolymer.

The amounts of units derived from particular monomers in a polymer or a block, and also the amounts of blocks in a block copolymer, can be determined by nuclear magnetic resonance analysis and/or by infrared spectrophotometry. They can also be deduced from the respective amounts of monomers used during the polymerization operations, taking into account the respective degrees of conversion of these monomers.

The block B has a weight-average molar mass of between 10 000 g/mol and 300 000 g/mol, preferentially 20 000 to 150 000 g/mol. This molar mass can be measured by size exclusion chromatography.

Each block may be a homopolymer or a copolymer.

The block A may for example be a polystyrene block.

However, it is preferred for the block A to be partly formed from one or more acrylic monomers, or even for it to be totally formed from one or more acrylic monomers. Optionally, the acrylic monomers may comprise one or more functions chosen from acid, amide, amine, hydroxyl, epoxy and alkoxy functions.

Thus, the block A may be a homopolymer chosen from poly(methyl methacrylate) (PMMA or pMMA), poly(phenyl methacrylate), poly(benzyl methacrylate) and poly(isobornyl methacrylate). It may also be a copolymer formed from styrene and from an acrylic monomer, such as acrylate or methacrylate in particular. In one embodiment, the block A is partly formed from methacrylic acid monomer, which confers on it an improved heat resistance.

In one preferred embodiment, the block A is PMMA. In another preferred embodiment, the block A is a copolymer of methyl methacrylate and of another acrylic comonomer. It may in particular be a copolymer of methyl methacrylate and of methacrylic acid, denoted p(MMA-co-AMA); or a copolymer of methyl methacrylate and of acrylic acid, denoted p(MMA-co-AA).

In another variant, the block A is PMMA containing a low proportion of units derived from an acrylate comonomer, in order to obtain improved heat stability.

The block B is advantageously at least partly formed from one or more acrylic monomers. Preferably, it is totally formed from acrylic monomers. Optionally, the acrylic monomers may comprise one or more functions chosen from acid, amide, amine, hydroxyl, epoxy and alkoxy functions.

Acrylic monomers which are preferred for the block B are methyl acrylate, ethyl acrylate, butyl acrylate, ethylhexyl acrylate and butyl methacrylate. Butyl acrylate is particularly preferred. The block B may be a homopolymer or a copolymer. In one preferred embodiment, the block B is poly(butyl acrylate) (pABu). In another preferred embodiment, the block B is copolymer of butyl acrylate and of styrene.

Preferentially, the block copolymer is chosen from the triblock and diblock copolymers listed in the summary of the invention.

The block copolymers can be obtained by controlled radical polymerization or by anionic polymerization.

Preferably, use is made of controlled radical polymerization, in particular in the presence of nitroxides, for sequenced copolymers comprising blocks of (A)ₙB type; and anionic or nitroxide-based radical or anionic polymerization for structures of ABA type.

It is understood that several block copolymers as described above can be used as a blend. However, preferably, a single block copolymer as described above is present in the polymer matrix of the composite material of the invention.

According to one embodiment, the polymer matrix of the composite material of the invention essentially consists of, or even consists of, the block copolymer described above (or the blend of such copolymers).

According to one embodiment, the composite material can comprise at least one other polymer in a blend with the block copolymer. This other polymer may be present in an intimate blend with the block copolymer as part of the polymer matrix, or alternatively in the form of particles dispersed in the polymer matrix.

Thus, the composite material, and preferably the polymer matrix of the composite material, can comprise another thermoplastic polymer. Preferably, this other thermoplastic polymer can be chosen from PMMAs, polystyrenes, optionally plasticized PVC, MABSs (Methylmethacrylate Acrylonitrile Butadiene Styrene), polyolefins and copolymers thereof (PE, PP homo- or copolymers), polymers of acrylonitrile-butadiene-styrene (ABS) terpolymer type, thermoplastic elastomers such as thermoplastic copolyamides, thermoplastic polyurethanes or elastomers of the styrene family, such as polystyrene-b-poly(ethylene-butylene)-b-polystyrene, biobased polymers and in particular PLA. It can advantageously be polyvinylidene fluoride or any other fluoropolymer in order to improve the fire resistance. It can also be an acrylic copolymer which contains, by weight, from 20% to 80% of units derived from methyl methacrylate, from 20% to 80% by weight of units derived from butyl methacrylate and from 0% to 15% of units derived from methacrylic acid or from acrylic acid. More preferentially, this acrylic copolymer contains, by weight, from 50% to 80% of units derived from methyl methacrylate and from 20% to 50% of units derived from butyl methacrylate. This acrylic copolymer advantageously has a weight-average molar mass of between 40 000 g/mol and 300 000 g/mol, and preferentially between 40 000 and 100 000 g/mol. When this acrylic copolymer is added to the composition, the material according to the invention may then preferably contain, by weight, from 5% to 40% of this acrylic copolymer, preferentially from 5% to 20%. This acrylic copolymer makes it possible in particular to improve the adhesion of the material of the invention on styrene substrates such as crystal polystyrene (PS) (PS homopolymer) or impact PS or a blend of these two types of PS. The term “impact PS” is intended to mean a PS reinforced against impacts by the addition of rubber, such as polybutadiene or EPDM (ethylene propylene diene monomer) which is dispersed in the PS matrix in the form of nodules.

When the block A is polystyrene or a styrene copolymer, polyphenylene oxide (PPO) can be introduced into the composition of the invention, in particular into the matrix, in order to increase the fire resistance.

When such a thermoplastic polymer is present, it is generally present at a weight content of from 1% to 20% relative to the block copolymer described above, but contents ranging up to 90% can also be used with some thermoplastics, such as some polyolefins.

The composite material (and preferably the polymer matrix of the composite material) can also comprise a highly crosslinked acrylic polymer. Such a polymer is capable of conferring, on the material after use, a non-shiny surface finish and/or a different feel. When such a polymer is present, it is generally present at a weight content of from 5% to 20% relative to the block copolymer described above.

The highly crosslinked acrylic polymer is formed from methyl methacrylate as single monomer, or as major monomer. Thus, the polymer comprises, by weight, more than 50%, advantageously more than 65% by weight of units derived from methyl methacrylate. The highly crosslinked acrylic polymer is therefore either a PMMA or a copolymer obtained with at least one comonomer that is copolymerizable, via radical polymerization, with methyl methacrylate.

The comonomer can be a vinylaromatic comonomer, for example styrene or alpha-methylstyrene and/or a (meth)acrylic comonomer. The amount of comonomer, when it is present, is preferably less than or equal to 50% of the weight of the highly crosslinked acrylic copolymer.

The crosslinking is obtained using at least one crosslinking agent which may, for example, be an allyl (meth)acrylate, divinylbenzene, or a di- or trimethacrylate such as polyethylene glycol dimethacrylate.

The term “highly crosslinked” means that the particles of acrylic polymer are insoluble in a polar solvent such as tetrahydrofuran or methylene chloride.

Reference is made herein to document WO 2012/136941, which describes in detail matrices of an acrylic block copolymer as described above, containing particles of highly crosslinked acrylic polymer as described above.

According to one preferred embodiment, the polymer matrix of the composite material of the invention is not crosslinked.

According to one preferred embodiment, the material of the invention is devoid, or essentially devoid, of natural rubber.

According to one preferred embodiment, the material of the invention is devoid, or essentially devoid, of ethylene-vinyl acetate.

According to one preferred embodiment, the material of the invention is devoid, or essentially devoid, of polyvinyl chloride.

According to one preferred embodiment, the material of the invention is devoid, or essentially devoid, of polyolefins such as polyethylene (PE) or polypropylene (PP) homopolymer, or of copolymers containing PE or PP.

According to one preferred embodiment, the material of the invention is devoid, or essentially devoid, of polymers containing a crystalline or semicrystalline phase.

Various additives can be added to the composite material according to the invention, and in particular to the polymer matrix of the composite material.

These additives can in particular be antioxidants, heat stabilizers, photostabilizers, plasticizers, UV-absorbers, antistatics, fire retardants or pigments.

A chemical blowing agent or a blowing gas such as CO₂ can also be used as additive. The blowing of the material according to the invention makes it possible to reduce its density and/or to increase its thermal and/or sound insulation properties.

Moreover, the composite material according to the invention comprises particles of plant material which are dispersed in the polymer matrix. Advantageously, these particles result from the milling of plants or parts of plants. The plants in question are preferably trees. More particularly preferably, they are particles of tree bark, and very preferentially particles of cork or of cork-oak bark.

It is preferred for the particles of plant material that are used to have a low density, in particular in order to confer good lightness properties on the material.

Thus, the density of the plant material is preferably less than or equal to 500 kg/m³; or less than or equal to 400 kg/m³; or less than or equal to 300 kg/m³; or less than or equal to 200 kg/m³; or less than or equal to 150 kg/m³; or less than or equal to 100 kg/m³; or less than or equal to 80 kg/m³; or less than or equal to 70 kg/m³; or less than or equal to 60 kg/m³.

The density of the plant material can be measured according to the standard ISO 2031 (2015).

The particle size distribution of the particles of plant material can be such that at least 80% (by weight) of the particles have a size of less than or equal to 2 mm.

According to one variant, at least 80% (by weight) of the particles have a size of between 1 and 2 mm.

According to one variant, at least 80% (by weight) of the particles have a size of between 0.5 and 1 mm.

According to one variant, at least 80% (by weight) of the particles have a size of less than or equal to 0.5 mm.

The particle size distribution of the particles can be measured by mechanical sieving according to the standard ISO 2030 (1990).

The use of particles of small size makes it possible in particular to obtain a composite material with a smoother and more uniform appearance.

The composite material according to the invention preferably comprises, by weight: from 30% to 99%, advantageously from 40% to 95% and preferably from 50% to 90%, of polymer matrix; and from 1% to 70%, advantageously from 5% to 60% and preferably from 10% to 50%, of particles of plant material.

Preferably, the weight content of the particles of plant material in the composite material is at least 10% less, preferably at least 15% less and more preferably at least 20% less than the weight content of the blocks B of the block copolymer described above in the composite material.

Advantageously, the composite material according to the invention has a semi-rigid, or even flexible, nature, while at the same time keeping a very good impact strength and resistance to UV-radiation. In the context of the present invention, a semi-rigid material is characterized by a flexural modulus ranging from 500 to less than 1800 MPa, preferably less than 1500 MPa, whereas a flexible material has a flexural modulus of from 10 to less than 500 MPa, measured according to the standard ISO 178 (2001).

Advantageously, the composite material according to the invention has a Charpy impact strength greater than 6 kJ/m², preferably greater than 10 kJ/m², measured according to the standard EN ISO 179-leU (1993) at 23° C.

Advantageously, the composite material according to the invention has a surface resistivity of less than 10×10¹² Ω/sq (ohms squared), preferably less than 10×10¹¹ Ω/sq, measured according to the standard ASTM D257-99 (2005).

Advantageously, the composite material according to the invention has a density of less than 1.

The composite material of the invention can be obtained by dispersing the particles of plant material, and also any other possible particles of one or more additives chosen from those mentioned above, in the polymer matrix in the softened state (compounding). This step can be carried out using the conventional techniques of manufacturing thermoplastic compounds, for example using an internal mixer, by carrying out single-screw or twin-screw extrusion, or by carrying out calendering.

In a first embodiment, the composite material according to the invention is first manufactured in the form of granules, which can then be softened and formed in order to manufacture various objects and articles.

In an alternative embodiment, objects and articles made of composite material according to the invention are manufactured directly by mixing the constituents of the composite material and by forming the material.

In one or the other embodiment, the objects and articles made of composite material according to the invention can be manufactured in particular by injection molding, extrusion, co-extrusion or extrusion-blow molding.

These various techniques make it possible in particular to produce parts, profiled parts, sheets or films.

The composite material of the invention can also be used as a coating on other materials. For example, use may be made of the technique of co-extrusion or lamination of a film on a substrate. Profiled parts that can be used for example in optical applications can also be produced.

It is also possible to manufacture multilayer structures comprising a first layer consisting of the composite material according to the invention and a second layer comprising at least one substrate made of a thermoplastic polymer material.

The composite material according to the invention then preferably represents from 1% to 99% of the total thickness expressed in units of length, from 1% to 50%, more particularly preferably from 2% to 15%.

When the composite material of the invention is co-extruded or laminated on a substrate, the latter can for example be a saturated polyester, such as polyethylene terephthalate PET or PETg, or polybutylene terephthalate, an ABS, a styrene-acrylonitrile copolymer, an acrylic-styrene-acrylonitrile copolymer, a crystal or impact PS, a thermoplastic polyolefin (TPO), polypropylene, polyethylene, polycarbonate (PC), polyphenylene oxide (PPO), a polysulfone, an optionally chlorinated or expanded polyvinyl chloride, a polyurethane, a TPU, a polyacetal, a non-impact PMMA or an impact PMMA. It may also be a blend of two or more thermoplastic polymers from the above list. For example, it may be a PPO/PS or PC/ABS blend. When the substrate is a crystal or impact PS, the composite materials according to the invention can advantageously contain, as additive, from 5% to 40% of acrylic copolymer composed of from 20% to 80% of units derived from methyl methacrylate, from 20% to 80% of units derived from butyl methacrylate and from 0% to 15% of acrylic acid or of methacrylic acid.

A layer of another polymer may be present between the substrate and the products according to the invention in order to improve the adhesion, in particular in the case of the substrates made of crystal or impact PS, TPO and PO.

More generally, the composite material of the invention may be used to manufacture sheets, films, profiled parts or articles, such as outer casings for telephones, spectacles, shoe soles, insulating layers or sublayers for floors or insulation sheets, decking, profiled cladding parts, interior motor vehicle parts, domestic electrical appliance parts or electronic parts or furniture parts, leathergoods articles, bracelets, internal parts or frames of watchmaking objects, or else sports articles.

The composite material according to the invention can be coated with a varnish in order in particular to increase its shine and/or its abrasion resistance.

### EXAMPLES

The following examples illustrate the invention without limiting it.

A formulation of composite material according to the invention is manufactured from:
a pMMA-pBA-pMMA triblock copolymer containing 50% by weight of pBA, the weight-average molar mass of the pBA block being 50 000 g/mol;
and a powder of cork granules.

In a test A, the cork granules have a density of between 50 and 60 kg/m³, and at least 80% of the granules (by weight) have a size of between 0.5 and 1 mm.

In a test B, the cork granules have a density of between 50 and 60 kg/m³, and at least 80% of the granules (by weight) have a size of between 1 and 2 mm.

In the two tests, the triblock copolymer/cork particles weight ratio is 80/20.

In a (comparative) test C, the pure copolymer, without cork particles, is used.

The composite material of the invention is manufactured by compounding of the acrylic block copolymer and of the cork particles on a Buss@ MKS30 co-kneader.

The co-kneader consists of two single-screw extruders connected perpendicularly.

The first extruder, called kneading extruder, consists of a screw with a diameter of 30 mm and a length/diameter ratio equal to 17. The screw is moved by both a rotational and a translational movement. Spikes, called kneading fingers, are attached to the barrel. Contrary to a conventional single-screw extruder, the screw elements used on a co-kneader have a discontinuous pitch in order to allow the rotation of the screw in the presence of these kneading fingers. The interactions between the flights and the static kneading fingers, which combine dispersive and distributive mixing, allow good performance of the co-kneader in terms of dispersion. A side feeder and also a degassing dome are also fitted on this extruder.

The second single-screw extruder, connected perpendicularly to the first, is called discharge extruder. It is used in order to reduce the pressure variations caused by the translational movement of the first single-screw extruder. The die via which the material is extruded is at the outlet of the discharge extruder.

The constituents are introduced by gravimetric metering devices located above the co-kneader. These metering devices make it possible to feed the co-kneader with material with great accuracy.

The block copolymer is introduced in the main feeder of the co-kneader, whereas the cork is introduced in the side feeder. The rod of mixture obtained is extruded through a die located at the end of the screw of the discharge extruder. This rod is then cooled in a water bath before being granulated using a granulator.

The temperature profile used is the following:
100° C. in the kneading extruder at the level of the main feeder;
160° C. in the kneading extruder between the main feeder and the side feeder;
190° C. in the kneading extruder after the side feeder;
190° C. in the discharge extruder.

In the two tests A and B, the rotational speed of the screw of the kneading extruder is 320 rpm, the rotational speed of the screw of the discharge extruder is 40 rpm, the total flow rate of material is 8 kg·h⁻¹. The average pressure in the die is 13 bar in the test A and 14 bar in the test B.

The two products studied are dried for 8 hours at 50° C. They are then injected using a Billon type H260 press equipped with a screw of diameter 32 mm and with a mold having a closing force of 90T, with water cooling.

The temperature profile of the injection screw is 140° C. for the first zone and then 150° C. for the next five zones. The temperature of the softened product is 150° C. The injection speed is 20 mm/s. The temperature of the mold is 60° C. Tensile dumbbells and impact bars are injected in order to characterize the products.

The characterization of the products appears in table I:

TABLE I

| | Test A | Test B | Test C |
|---|---|---|---|
| Melt flow index | 5.8 | 4 | 9 |
| Flexural modulus | 125 | 120 | 300 |
| Non-notched Charpy impact | No break | No break | No break |
| Notched Charpy impact | 18 | 20 | 22 |
| Vicat softening temperature | 63 | 58.4 | 70 |
| Heat distortion temperature | 60.8 | 61.1 | 59 |
| Elongation at break | 32 | 36 | 55 |
| Density | 0.97 | | 1.1 |
| Surface resistivity | 5.3 × 10¹⁰ | 5.8 × 10¹⁰ | 6 × 10¹⁴ |

The melt flow index (MFI) is measured according to the standard ISO 1133 (January 1997) using the following parameters: 230° C. and 3.8 kg. It is expressed ing/10 mm.

The flexural modulus is measured according to the standard ISO 178 (2001), at 23° C. It is expressed in MPa.

The notched Charpy impact strength and non-notched Charpy impact strength are measured according to the standard ISO 179-leU (1993), at 23° C. They are expressed in kJ/m².

The softening temperature Vicat and is measured according to the standard ISO 306 (2004), with a force of 10 N. It is expressed in ° C.

The heat distortion temperature is measured according to the standard ISO 75-2 (1993), with a pressure of 1.80 MPa. It is expressed in ° C.

The tensile elongation at break is measured according to the standard ISO 527-2 (1996), at 23° C. It is expressed in %.

The density is measured using a helium pycnometer according to the standard ISO 1183-3 (1999).

The surface resistivity is measured using a Keithley 6514 electrometer equipped with a model 803B cell from the company Electro-tech systems, Inc. It is expressed in Ω/sq units.

The results presented in table I show that the composite products according to the invention, obtained during the tests A and B, have a flexibility, an impact strength and a temperature resistance that are very close to the properties of the product of the comparative test C, while having a cork appearance and a lower surface resistivity. Moreover, their fluidity remains sufficiently high, which made it possible to inject them at a low temperature (150° C.) in order to preserve the cork.

1-18: (canceled)

19. A composition, comprising:
a polymer matrix comprising an elastomer phase having a glass transition temperature of less than or equal to 20° C.; and
particles of cork dispersed in the polymer matrix.

20. The composition of claim 19, wherein the particles of cork have a density of less than or equal to 500 kg/m³.

21. The composition of claim 19, wherein:
the elastomer phase represents at least 1% by weight, relative to the total weight of the composition; and/or
the ratio of the weight content of particles of cork to the weight content of elastomer phase is less than or equal to 1.

22. The composition of claim 19, wherein the polymer matrix comprises at least one block copolymer, and wherein the elastomer phase is at least partially made up of at least one block of the block copolymer.

23. The composition of claim 22, comprising:
from 30% to 99% by weight of the block copolymer; and
from 1% to 70% by weight of the particles of cork.

24. The composition of claim 23, wherein the ratio of the weight content of particles of cork to the weight content of elastomer phase of the block copolymer is greater than or equal to 1, but less than or equal to 3.

25. The composition of claim 23, wherein the block copolymer comprises at least one block A having a glass transition temperature of greater than or equal to 50° C., and at least one block B having a glass transition temperature of less than or equal to 20° C., which at least partially constitutes the elastomer phase.

26. The composition of claim 25, wherein the block B represents from 10% to 90% of the total weight of the block copolymer.

27. The composition of claim 25, wherein the block A is an acrylic or methacrylic homopolymer or copolymer block, or a polystyrene block, or an acrylic-styrene copolymer block or a methacrylic-styrene block, optionally modified with acrylic or methacrylic comonomers.

28. The composition of claim 25, wherein the block B is an acrylic or methacrylic homopolymer or copolymer block.

29. The composition of claim 23, wherein the block copolymer is chosen from the following triblock copolymers:
poly(methyl methacrylate)/poly(butyl acrylate)/poly(methyl methacrylate),
copolymer of methyl methacrylate and of methacrylic acid/poly(butyl acrylate)/copolymer of methyl methacrylate and of methacrylic acid,
poly(methyl methacrylate)/copolymer of butyl acrylate and of styrene/poly(methyl methacrylate), and
copolymer of methyl methacrylate and of methacrylic acid/copolymer of butyl acrylate and of styrene/copolymer of methyl methacrylate and of methacrylic acid;
or wherein the block copolymer is chosen from the following diblock copolymers:
poly(methyl methacrylate)/poly(butyl acrylate),
copolymer of methyl methacrylate and of methacrylic acid/poly(butyl acrylate), polymer of methyl methacrylate/copolymer of butyl acrylate and of styrene,
copolymer of methyl methacrylate and of methacrylic acid/copolymer of butyl acrylate and of styrene,
polystyrene/poly(butyl acrylate)/polystyrene, and
poly(styrene-co-methacrylic acid)/poly(butyl acrylate)/poly(styrene-co-methacrylic acid).

30. The composition of claim 19, further comprising a thermoplastic polymer.

31. The composition of claim 30, wherein the thermoplastic polymer is a fluoropolymer.

32. The composition of claim 30, wherein the thermoplastic polymer is a biobased polymer.

33. The composition of claim 30, wherein the thermoplastic polymer is polyvinylidene fluoride or PLA.

34. The composition of claim 32, wherein, when the block A is a styrene block, the thermoplastic polymer is a polyphenylene oxide.

35. The composition of claim 19, blown by means of a chemical blowing agent and/or a blowing gas.

36. A process for preparing a composition of claim 19, comprising:
hot-mixing the polymer matrix in a softened state with the particles of cork and optionally with one or more additives, in an extruder, the particles of cork being introduced laterally after the introduction of the polymer matrix which is introduced into the feeder at the beginning of extrusion.

37. An article comprising the composition of claim 19.

38. The article of claim 37, which is selected from the group consisting of sheets, films, profiled parts or outer casings for telephones, spectacles, shoe soles, insulating layers or sublayers for floors or insulation sheets, decking, profiled cladding parts, interior motor vehicle parts, domestic electrical appliance parts or electronic parts or furniture parts, leathergoods articles, bracelets, internal parts or frames of watchmaking objects, and sports articles.
